(19) United States
(12) Patent Application Publication
(10) Pub. No.: US 2025/0310842 A1
(43) Pub. Date: Oct. 2, 2025

(54) MECHANISMS FOR LOWER LAYER TRIGGERED MOBILITY PROCEDURE

(71) Applicant: Wistron NeWeb Corp., Hsinchu (TW)

(72) Inventor: Hung-Chen CHEN, Hsinchu (TW)

(21) Appl. No.: 19/090,627

(22) Filed: Mar. 26, 2025

Related U.S. Application Data
(60) Provisional application No. 63/570,303, filed on Mar. 27, 2024.

(51) Int. Cl. H04W 36/04; H04W 36/08; H04W 76/20

(52) U.S. Cl. CPC H04W 36/04; H04W 36/08; H04W 76/20

(57) ABSTRACT

A method for a Layer 1/Layer 2 (L1/L2) triggered mobility (LTM) procedure is provided. The method is implemented by a user equipment (UE) and includes receiving one or more radio resource control (RRC) messages from a source base station. The method includes being configured with one or more LTM commands included in the one or more RRC messages, wherein a total number of the one or more LTM commands does not exceed a predetermined number, the one or more LTM commands include at least one of a first type of LTM command and a second type of LTM command, the first type of LTM command includes a first target cell configuration of a first target cell and a first execution condition, and the second type of LTM command includes a second target cell configuration of a second target cell without any execution condition.

### CROSS REFERENCE TO RELATED APPLICATIONS

This application claims the benefit of U.S. Provisional Application No. 63/570,303, entitled “Mechanisms for Conditional Lower Layer Triggered Mobility”, filed on Mar. 27, 2024, the entirety of which is incorporated by reference herein.

### TECHNICAL FIELD

The present disclosure generally relates to wireless communication. More specifically, aspects of the present disclosure relate to mechanisms for a Layer 1/Layer 2 (L1/L2) triggered mobility (LTM) procedure.

### BACKGROUND

Unless otherwise indicated herein, approaches described in this section are not prior art to the claims listed below and are not admitted as prior art by inclusion in this section.

A conventional handover (HO) procedure (i.e., Layer 3/L3 mobility) is introduced to HO a User Equipment (UE) from a source serving cell to a target serving cell, e.g., when the UE moves from the coverage area of the source serving cell to the coverage area of the target serving cell. The decision to perform a conventional HO is made by a current serving gNB (or the source gNB) of the current serving cell (or the source cell) based on measurement results reported from a UE. When the source gNB determines that a handover is necessary, the source gNB sends an HO request message to the target gNB to ask for the HO admission. When the target gNB accepts the HO request, it replies with an HO request acknowledge message, including necessary information/configuration for the UE to perform a conventional HO procedure to synchronize with a target cell of the target gNB. Upon receiving the HO request acknowledge message, the source gNB transmits an HO command (or a Radio Resource Control (RRC) Reconfiguration message with synchronization to the target cell), including at least the target cell configuration, to instruct the UE to perform a conventional HO procedure to the target cell. Therefore, the conventional HO procedure is triggered by Layer 3 (L3) measurement and is done by RRC signaling to instruct the UE to HO from a source cell to a target cell. However, the serving source gNB may not always receive measurement reports from the UE or may not successfully transmit a handover (HO) command to the UE due to faster signal degradation or higher UE speed. This translates to a higher rate of HO failures. Also, the conventional HO procedure involves complete L2 (and L1) resets, leading to longer latency, larger overhead and longer interruption time than beam switch mobility.

To reduce the latency, overhead, and interruption time, in 3rd Generation Partnership Project (3GPP) Release 18, LTM was introduced to improve HO latency and interruption time compared to the conventional HO procedure. By definition, LTM is a cell switch procedure that the network triggers via Medium Access Control (MAC) Control Element (CE) based on L1 measurements. It should be noted that based on 5G protocol stack, L1 is physical layer and L3 is Radio Resource Control (RRC) layer. L2 include MAC, Radio Link Control (RLC), Packet Data Convergence Protocol (PDCP), Service Data Adaptation Protocol (SDAP) layers. As stated in TS 38.300 of Release 18, LTM is a procedure in which a gNB receives an L1 measurement report from a UE, and on that basis the gNB changes the UE serving cell via a cell switch command signaled by an MAC CE. The cell switch command indicates an LTM candidate configuration that the gNB previously prepared and provided to the UE through RRC signaling. Then the UE switches to the target configuration according to the cell switch command.

FIG. 1 illustrates an example scenario 100 of signaling procedure for LTM as captured in TS 38.300 of Release 18. The scenario 100 involves a UE and a next-generation NB (gNB) (e.g., a base station (BS) or a transmission and reception point (TRP)) which may be part of a wireless network (e.g., a 5G NR network, a 5G network, or a 6G network). As shown in FIG. 1, the signaling procedure for LTM is performed when the UE is in the RRC_CONNECTED state.

In step 101, the UE transmits a MeasurementReport message to the gNB. Upon receiving the MeasurementReport message, the gNB decides to configure LTM and initiates LTM candidate preparation.

In step 102, the gNB transmits an RRCReconfiguration message to the UE, which includes the configuration of one or multiple LTM candidate cells.

In step 103, the UE stores the configuration of LTM candidate cell(s) and transmits an RRCReconfigurationComplete message to the gNB.

In step 104a, the UE may perform downlink (DL) synchronization with candidate cell(s) before receiving the LTM cell switch command.

In step 104b, the UE may perform uplink (UL) synchronization and timing advance (TA) acquisition with candidate cell(s) before receiving the LTM cell switch command. In cases where UE-based TA measurement is configured (as introduced in TS 38.331 of Release 18), the UE acquires the TA value(s) of the candidate cell(s) using the UE-based TA measurement. Alternatively, the UE performs early TA acquisition with the candidate cell(s) as requested by the gNB before receiving the LTM cell switch command. This is done via Contention-Free Random Access (CFRA) triggered by a Physical Downlink Control Channel (PDCCH) order from a source cell, following which the UE sends preamble towards the indicated candidate cell. In order to minimize the data interruption of the source cell due to CFRA towards the candidate cell(s), the UE does not receive a random access response from the gNB for the purpose of TA value acquisition and the TA value of the candidate cell is indicated in the LTM cell switch command. The UE does not maintain the TA timer for the candidate cell and relies on network implementation to guarantee the TA validity.

In step 105, the UE performs L1 measurements on the configured LTM candidate cell(s), and transmits an L1 measurement reports to the gNB, wherein the L1 measurements should be performed as long as RRC reconfiguration (in step 102) is applicable. Upon receiving the L1 measurement reports, the gNB may decide to execute the LTM cell switch to a target cell.

In step 106, the gNB decides to execute cell switch to the target cell and transmits an MAC control element (MAC-CE) triggering cell switch by including the candidate configuration index of the target cell. In response to the triggering of LTM cell switch, the UE switches to the target cell and applies the configuration indicated by candidate configuration index.

In step 107, the UE performs a random access procedure towards the target cell, when the UE does not have valid TA of the target cell as specified in TS 38.321 of Release 18.

In step 108, the UE completes the LTM cell switch procedure by sending RRCReconfigurationComplete message to the target cell. When the UE has performed an RA procedure in step 107 and the random access procedure is successfully completed, the UE considers that LTM cell switch procedure is successfully completed. For RACH-less LTM, the UE considers that LTM cell switch procedure is successfully completed when the UE determines that the gNB has successfully received its first UL data. It should be noted that RACH-less LTM is an LTM cell switch procedure where the UE skips the random access procedure.

In the design of Release 18, LTM still has room for further improvements. In RP-234036, a new work item was approved for further New Radio (NR) mobility enhancement. One of the objectives of this new work item is to support conditional LTM to achieve higher robustness by following the concept of conditional handover (CHO). As introduced in TS 38.300 v16.15.0, a CHO is defined as a handover that is executed by the UE when one or more handover execution conditions are met, without necessitating a signaling exchange with source cell beforehand. By introducing conditional LTM mechanism, UE mobility can benefit from both the high robustness and short interruption.

However, many details of the whole conditional LTM design are not yet defined, e.g., related configuration design for supporting conditional LTM design, means to perform early UL synchronization (or acquire valid timing advance/TA value) to a target candidate cell for conditional LTM design considering that LTM Cell Switch Command MAC CE (as specified in TS 38.321 of Release 18) may need to be modified to support the conditional LTM, corresponding UE behavior to perform a conditional LTM procedure, and etc.

As such, how to design conditional LTM procedure has become an important issue. Therefore, there is a need to provide proper schemes to address this issue.

### SUMMARY

The following summary is illustrative only and is not intended to be limiting in any way. That is, the following summary is provided to introduce concepts, highlights, benefits and advantages of the novel and non-obvious techniques described herein. Select, not all, implementations are described further in the detailed description below. Thus, the following summary is not intended to identify essential features of the claimed subject matter, nor is it intended for use in determining the scope of the claimed subject matter.

Therefore, mechanisms for a conditional Layer 1/Layer 2 (L1/L2) triggered mobility (LTM) procedure are provided in the present disclosure. The main purpose of the disclosure is to support the conditional LTM procedure, including the UE assistance information for supporting decisions of the network on the conditional LTM, detailed designs of the conditional LTM configuration, UE behavior upon receiving or releasing the conditional LTM configuration, UE behavior under the condition that a conditional LTM configuration coexists with a traditional LTM configuration or a CHO command, and a modified LTM Cell Switch Command MAC CE providing a TA value for the early UL synchronization to a target candidate cell.

In an exemplary embodiment, a method for a Layer 1/Layer 2 (L1/L2) triggered mobility (LTM) procedure is provided. The method is implemented by a user equipment (UE) and comprises receiving one or more radio resource control (RRC) messages from a source base station. The method comprises being configured with one or more LTM commands included in the one or more RRC messages, wherein a total number of the one or more LTM commands does not exceed a predetermined number. The one or more LTM commands comprise at least one of a first type of LTM command and a second type of LTM command, the first type of LTM command includes a first target cell configuration of a first target cell and a first execution condition, and the second type of LTM command includes a second target cell configuration of a second target cell without any execution condition.

In an exemplary embodiment, an apparatus for a Layer 1/Layer 2 (L1/L2) triggered mobility (LTM) procedure is provided. The apparatus comprises a transceiver and a processor. The transceiver which, during operation, wirelessly communicates with at least one network node. The processor communicatively coupled to the transceiver such that, during operation, the processor performs operations comprising receiving one or more radio resource control (RRC) messages from a source base station; and being configured with one or more LTM commands included in the one or more RRC messages, wherein a total number of the one or more LTM commands does not exceed a predetermined number. The one or more LTM commands comprise at least one of a first type of LTM command and a second type of LTM command, the first type of LTM command includes a first target cell configuration of a first target cell and a first execution condition, and the second type of LTM command includes a second target cell configuration of a second target cell without any execution condition.

In an exemplary embodiment, a method for a Layer 1/Layer 2 (L1/L2) triggered mobility (LTM) procedure is provided. The method is implemented by a source base station (BS) and comprises transmitting a one or more radio resource control (RRC) messages to a user equipment (UE), wherein one or more LTM commands included in the one or more RRC messages are configured to the UE, a total number of the one or more LTM commands does not exceed a predetermined number, the one or more LTM commands comprise at least one of a first type of LTM command and a second type of LTM command, the first type of LTM command includes a first target cell configuration of a first target cell and a first execution condition, and the second type of LTM command includes a second target cell configuration of a second target cell without any execution condition.

### BRIEF DESCRIPTION OF THE DRAWINGS

The accompanying drawings are included to provide a further understanding of the present disclosure, and are incorporated in and constitute a part of the present disclosure. The drawings illustrate implementations of the disclosure and, together with the description, serve to explain the principles of the disclosure. It should be appreciated that the drawings are not necessarily to scale as some components may be shown out of proportion to their size in actual implementation in order to clearly illustrate the concept of the present disclosure.

FIG. 1 illustrates an example scenario of signaling procedure for LTM.

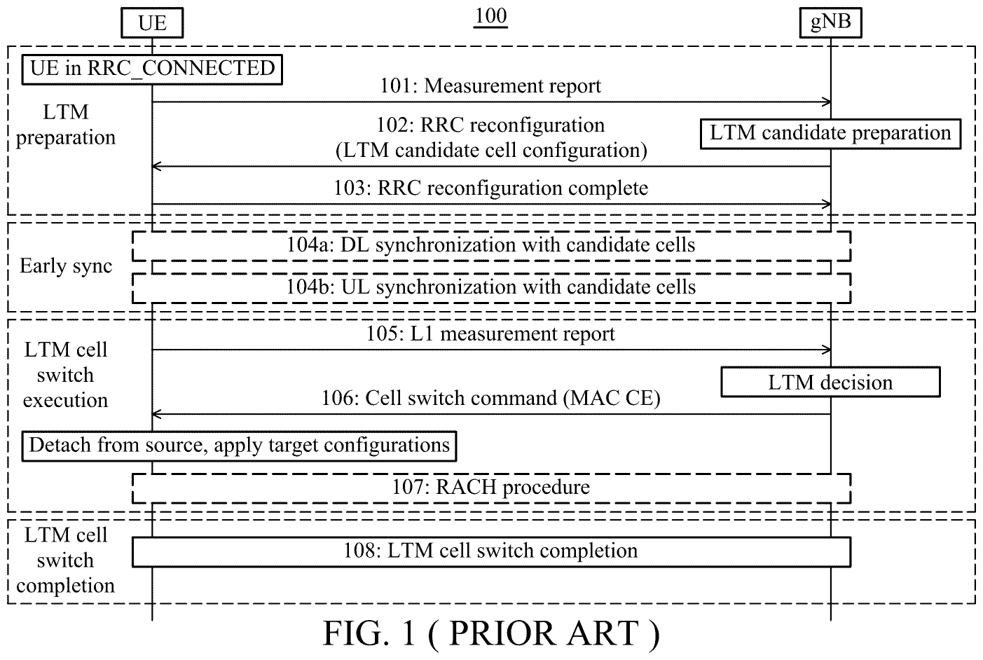

FIG. 2 shows a conditional LTM procedure according to an implementation of the present disclosure.

FIG. 3 shows a signaling procedure of transmitting UE assistance information according to an implementation of the present disclosure.

FIG. 4 shows a configuration structure of the LTM configuration comprising one or more LTM candidate configurations according to an implementation of the present disclosure.

FIG. 5 shows an early UL TA acquisition procedure triggered by a PDCCH order according to an implementation of the present disclosure.

FIG. 6 shows an LTM Cell Switch Command MAC CE according to an implementation of the present disclosure.

FIG. 7 is a block diagram of an example communication system in accordance with an implementation of the present disclosure.

FIG. 8 is a flowchart of an example process in accordance with an implementation of the present disclosure.

### DETAILED DESCRIPTION

The following description contains specific information pertaining to example implementations in the present disclosure. The drawings in the present disclosure and their accompanying detailed description are directed to merely example implementations. However, the present disclosure is not limited to merely these example implementations. Other variations and implementations of the present disclosure will occur to those skilled in the art. Unless noted otherwise, like or corresponding elements among the figures may be indicated by like or corresponding reference numerals. Moreover, the drawings and illustrations in the present disclosure are generally not to scale and are not intended to correspond to actual relative dimensions.

For the purpose of consistency and ease of understanding, like features may be identified (although, in some examples, not shown) by the same numerals in the example figures. However, the features in different implementations may be differed in other respects, and thus shall not be narrowly confined to what is shown in the figures.

The description uses the phrases “in one implementation,” or “in some implementations,” which may each refer to one or more of the same or different implementations. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series and the equivalent. The expression “at least one of A, B and C” or “at least one of the following: A, B and C” means “only A, or only B, or only C, or any combination of A, B and C.”

Additionally, for the purposes of explanation and non-limitation, specific details, such as functional entities, techniques, protocols, standard, and the like are set forth for providing an understanding of the described technology. In other examples, detailed description of well-known methods, technologies, systems, architectures, and the like are omitted so as not to obscure the description with unnecessary details.

Persons skilled in the art will immediately recognize that any network functions or algorithms described in the present disclosure may be implemented by hardware, software or a combination of software and hardware. Described functions may correspond to modules which may be software, hardware, firmware, or any combination thereof. The software implementation may comprise computer executable instructions stored on computer readable medium such as memory or other type of storage devices. For example, one or more microprocessors or general-purpose computers with communication processing capability may be programmed with corresponding executable instructions and carry out the described network functions or algorithms. The microprocessors or general-purpose computers may be formed of Applications Specific Integrated Circuitry (ASIC), programmable logic arrays, and/or using one or more Digital Signal Processor (DSPs). Although some of the example implementations described in this specification are oriented to software installed and executing on computer hardware, nevertheless, alternative example implementations implemented as firmware or as hardware or combination of hardware and software are well within the scope of the present disclosure.

The computer readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture (e.g., a Long Term Evolution (LTE) system, an LTE-Advanced (LTE-A) system, an LTE-Advanced Pro system, a 5G New Radio (NR) Radio Access Network (RAN) or a 6G NR RAN) typically includes at least one Base Station (BS), at least one User Equipment (UE), and one or more optional network elements that provide connection towards a network. The UE communicates with the network (e.g., a Core Network (CN), an Evolved Packet Core (EPC) network, an Evolved Universal Terrestrial Radio Access Network (E-UTRAN), a 5G Core (5GC), or an internet), through an RAN established by one or more BSs.

It should be noted that, in the present disclosure, a UE may include, but is not limited to, a mobile station, a mobile terminal or device, or a user communication radio terminal. For example, a UE may be a portable radio equipment, which includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a radio access network.

A BS may be configured to provide communication services according to at least one of the following Radio Access Technologies (RATs): Worldwide Interoperability for Microwave Access (WiMAX), Global System for Mobile communications (GSM, often referred to as 2G), GSM Enhanced Data rates for GSM Evolution (EDGE) Radio Access Network (GERAN), General Packet Radio Service (GRPS), Universal Mobile Telecommunication System (UMTS, often referred to as 3G) based on basic Wideband-Code Division Multiple Access (W-CDMA), High-Speed Packet Access (HSPA), LTE, LTE-A, eLTE (evolved LTE, e.g., LTE connected to 5GC), NR (often referred to as 5G), 6G and/or LTE-A Pro. However, the scope of the present disclosure should not be limited to the above-mentioned protocols.

A BS may include, but is not limited to, a node B (NB) as in the UMTS, an evolved Node B (eNB) as in the LTE or LTE-A, a Radio Network Controller (RNC) as in the UMTS, a Base Station Controller (BSC) as in the GSM/GERAN, a ng-eNB as in an Evolved Universal Terrestrial Radio Access (E-UTRA) BS in connection with the 5GC, a next-generation Node B (gNB) as in the 5G-RAN, and any other apparatus capable of controlling radio communication and managing radio resources within a cell. The BS may serve one or more UEs through a radio interface.

The BS is operable to provide radio coverage to a specific geographical area using a plurality of cells forming the radio access network. The BS supports the operations of the cells. Each cell is operable to provide services to at least one UE within its radio coverage. More specifically, each cell (often referred to as a serving cell) provides service to one or more UEs within its radio coverage (e.g., each cell schedules the downlink and optionally uplink resources to at least one UE within its radio coverage for downlink and optionally uplink packet transmissions). The BS can communicate with one or more UEs in the radio communication system through the plurality of cells. A cell may allocate Sidelink (SL) resources for supporting Proximity Service (ProSe) or Vehicle to Everything (V2X) service. Each cell may have overlapping coverage areas with other cells.

As discussed above, the frame structure for NR is to support flexible configurations for accommodating various next-generation (e.g., 5G) communication requirements, such as Enhanced Mobile Broadband (eMBB), Massive Machine Type Communication (mMTC), Ultra-Reliable and Low-Latency Communication (URLLC), while fulfilling high reliability, high data rate and low latency requirements. The Orthogonal Frequency-Division Multiplexing (OFDM) technology as agreed in the 3rd Generation Partnership Project (3GPP) may serve as a baseline for NR waveform. The scalable OFDM numerology, such as the adaptive sub-carrier spacing, the channel bandwidth, and the Cyclic Prefix (CP) may also be used. Additionally, two coding schemes are considered for NR: (1) Low-Density Parity-Check (LDPC) code and (2) Polar Code. The coding scheme adaption may be configured based on the channel conditions and/or the service applications.

Moreover, it is also considered that in a transmission time interval TX of a single NR frame, a Downlink (DL) transmission data, a guard period, and an Uplink (UL) transmission data should at least be included, where the respective portions of the DL transmission data, the guard period, the UL transmission data should also be configurable, for example, based on the network dynamics of NR. In addition, SL resources may also be provided in an NR frame to support ProSe services or V2X services.

In addition, the terms “system” and “network” herein may be used interchangeably. The term “and/or” herein is only an association relationship for describing associated objects and represents that three relationships may exist. For example, A and/or B may indicate that: A exists alone, A and B exist at the same time, or B exists alone. In addition, the character “/” herein generally represents that the former and latter associated objects are in an “or” relationship.

### Signaling Procedure for Conditional LTM

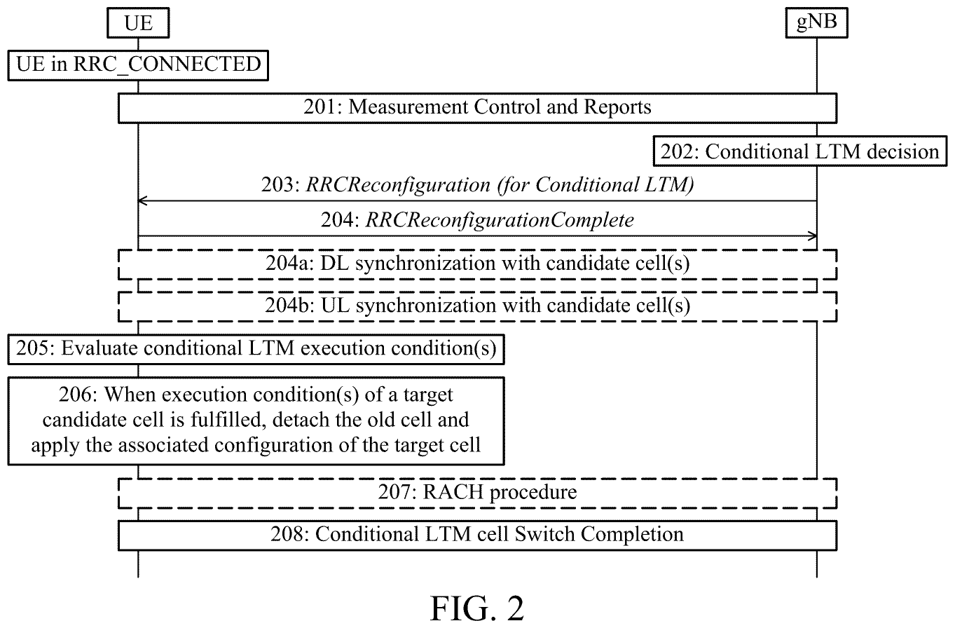

FIG. 2 shows a conditional LTM procedure according to an implementation of the present disclosure. It should be noted that one or more steps in FIG. 2 may or may not be performed. For example, the RACH procedure in Step 207 may not be performed when the UL synchronization in Step 204b is completed. Also, the order of the steps may not be mandatory. For example, the UE may start evaluating (configured) conditional LTM condition(s) before transmitting the RRCReconfigurationComplete message in Step 204.

In step 201, for the UE in the RRC_CONNECTED state, a serving gNB of the UE may configure UE measurement procedures, e.g., by providing L1 measurement configuration(s) or L3 measurement configuration(s), and the UE may report measurement results based on the L1 measurement configuration(s) or the L3 measurement configuration(s). The L1 measurement configuration or the L3 measurement configuration may be provided for Channel State Information Reference Signal (CRI-RS) based measurements or Synchronization Signal Block (SSB) based measurements for a specific target candidate cell. Based on the received measurement configuration(s), the UE may periodically report the measurement results to the serving gNB or the measurement results may be reported by event-triggered.

In step 202, the serving gNB may decide to use a conditional LTM, e.g., based on the received measurement results from the UE, a UE speed, or a current operating frequency. In one implementation, the serving gNB may configure the UE to provide assistance information for the serving gNB to determine whether the conditional LTM is required for the UE mobility (or a cell switch procedure). For example, the assistance information may include a UE speed, a UE mobility status, a UE location or a UE trajectory, but it should not be limited in the disclosure. In another implementation, the UE may provide its preference for using the conditional LTM or not. The serving gNB may make a decision on using the conditional LTM based on the assistance information provided by the UE.

In step 203, the serving gNB may transmit an RRCReconfiguration message to the UE, including at least the LTM candidate configuration(s) and conditional LTM execution condition(s). It should be noted that the conditional LTM candidate configuration includes as least one LTM candidate configuration (of a target candidate cell) and at least one associated conditional LTM execution condition. It should be noted that “candidate target cell configuration for the conditional LTM”, “candidate target cell configuration”, “conditional LTM command” and “LTM candidate configuration” are exchangeable in this disclosure. The conditional LTM candidate configuration may also be identified by a (conditional) LTM ID. The (conditional) LTM ID may be assigned by the (source) serving gNB. The serving gNB may release the conditional LTM candidate configuration by indicating its associated (conditional) LTM ID in a network (NW) signaling. Also, “conditional LTM execution condition(s)” and “execution condition(s)” may be exchangeable in this disclosure. The execution condition may be associated with a measurement ID (e.g., measID) or an associated measurement report configuration (e.g., a measurement configuration with a ReportConfig ID associated with the measurement ID). The associated measurement report configuration may be provided for SSB based L1 measurement(s), CRI-RS based L1 measurement(s), SSB based L3 measurement(s), or CRI-RS based L3 measurement(s). The associated measurement report configuration may be indicated for the conditional LTM. In cases where the associated measurement report configuration is indicated for the conditional LTM (e.g., a specific information element is present in the measurement report configuration), the UE may evaluate the configured measurement event(s) without reporting any measurement results to the serving gNB. For example, the UE may perform an L1 based execution condition evaluation based on an associated report configuration related to a target candidate cell. For another example, the UE may perform an L3 based execution conditional evaluation based on an associated report configuration related to a target candidate cell. In one implementation, whether the measurement results associated with a satisfied execution condition are sent to the serving gNB may be configured by the serving gNB. In one implementation, the initial state of the execution condition(s) associated with the LTM candidate configuration may be disabled/inactive or enabled/active. The initial state of the execution condition(s) associated with the LTM candidate configuration may be configured by the serving gNB. In one implementation, the default state of the execution condition(s) associated with the LTM candidate configuration may be disabled or inactive. In one implementation, the default state of the execution condition(s) associated with the LTM candidate configuration may be enabled or active. In another implementation, the serving gNB may change the state of the execution condition(s) associated with the LTM candidate configuration (e.g., via an RRC signaling, an MAC CE, or a DCI). For example, the serving gNB may use a NW command (e.g., via an RRC signaling, an MAC CE, or a DCI) to enable the execution condition(s) associated with the LTM candidate configuration #1 such that the UE may start evaluating the execution condition(s) associated with the LTM candidate configuration #1. In another example, the serving gNB may use a NW command (e.g., via an RRC signaling, an MAC CE, or a DCI) to disable the execution condition(s) associated with an LTM candidate configuration #2 such that the UE may stop evaluating the execution condition(s) associated with the LTM candidate configuration #2.

In step 204a, the UE may perform a (early) DL synchronization procedure with a target candidate cell before applying the LTM candidate configuration of the target candidate cell. It should be noted that the LTM candidate configuration may be applied since the conditional LTM execution condition(s) associated with the LTM candidate configuration is fulfilled. Whether the UE may perform the (early) DL synchronization procedure with a target candidate cell before applying the LTM candidate configuration of the target candidate cell may depend on network configuration(s) or control signaling. In one implementation, the RRCReconfiguration message or the conditional LTM candidate configuration may include an indication (or related information) to indicate whether a (early) DL synchronization procedure is required.

In step 204b, the UE may perform a (early) UL synchronization procedure with the target candidate cell before applying the LTM candidate configuration of the target candidate cell. It should be noted that the LTM candidate configuration may be applied since the conditional LTM execution condition(s) associated with the LTM candidate configuration is fulfilled. Whether the UE may perform the (early) UL synchronization procedure with a target candidate cell before applying the LTM candidate configuration of the target candidate cell may depend on network configuration(s) or the NW control signaling. To perform the (early) UL synchronization procedure, the serving gNB may provide uplink resources (e.g., RA resources or a PDCCH order) for the UE to at least transmit a preamble in advance before the conditional LTM configuration associated with the target candidate cell is applied. In one implementation, after the UE transmits a preamble to a target candidate cell, the UE may receive a random access response (RAR) (e.g., including a TA command) from the target candidate cell in cases where the early UL synchronization procedure is performed for the conditional LTM. For this case, a current serving cell (or the base station of the current serving cell) may provide an additional measurement gap configuration for the UE to transmit a preamble and/or receive the corresponding RAR from a target candidate cell. In another implementation, after a UE transmits a preamble to a target candidate cell, the UE may receive a modified LTM Cell Switch Command MAC CE (or an RAR, a new MAC CE) from the current serving cell (or the base station of the current serving cell) in cases where the early UL synchronization procedure is performed for the conditional LTM. The received modified LTM cell Switch Command MAC (or an RAR, a new MAC CE) may include a TA command (or TA related information) for a target candidate cell, which may be applied to connect to the target candidate cell.

In step 205, the UE may start evaluating conditional LTM execution condition(s) upon receiving the conditional LTM candidate configuration(s). In one implementation, the UE may start evaluating the conditional LTM execution condition(s) associated with the LTM candidate configuration when the execution condition(s) is enabled, active, valid, or configured. The UE may stop evaluating the conditional LTM execution condition(s) once a handover is executed (e.g., a traditional LTM is executed, a conditional LTM is executed, a traditional HO is executed, or a CHO is executed). In one implementation, the UE may stop evaluating the conditional LTM execution condition(s) associated with the LTM candidate configuration when the execution condition(s) is disabled, inactive, invalid or de-configured. In another implementation, whether the UE may start evaluating the conditional LTM execution condition(s) associated with the LTM candidate configuration may depend on its current state (e.g., enabled or disabled).

In step 206, the UE may maintain connection with the current serving gNB after receiving the conditional LTM candidate configuration(s) and may start evaluating the conditional LTM execution condition(s) for target candidate cell(s) associated with the received conditional LTM candidate configuration(s). When at least one target candidate cell satisfies the corresponding conditional LTM execution condition(s), the UE may detach from the current serving gNB, trigger the LTM cell switch procedure, and/or apply the stored LTM candidate configuration for that selected target candidate cell. In one implementation, when more than one target candidate cell satisfies the corresponding conditional LTM execution condition(s), the UE may randomly select a target candidate cell to trigger the LTM cell switch procedure by applying the stored LTM candidate configuration of the selected target candidate cell.

In step 207, the UE may perform the RA procedure towards the target cell, when the UE does not have valid TA of the target candidate cell or the early UL synchronization procedure is not successfully completed. The UE may have a valid TA provided by the serving gNB or may calculate or measure a valid TA by itself. The serving gNB may instruct the UE to calculate or measure a valid TA to a target candidate cell by itself.

In step 208, the UE may complete the conditional LTM procedure by sending the RRCReconfigurationComplete message to the selected target candidate cell (or its associated gNB). After the UE has performed the RA procedure in step 207, the UE may consider that the conditional LTM procedure is successfully completed when the random access procedure is successfully completed. The RRCReconfigurationComplete message may include an information element field to indicate the LTM ID of the selected conditional LTM candidate configuration the UE applies upon the execution of conditional LTM. When the UE has a valid TA of the selected target candidate cell and no RA procedure is required to be performed, the UE may consider that the conditional LTM procedure is successfully completed when the UE determines that the network (or the new serving gNB) has successfully received the first UL data of the UE.

In one implementation, when subsequent conditional LTM is configured, the UE starts evaluating the execution conditions of the conditional LTM candidate configuration(s) associated with the new serving cell, if any.

In one implementation, while the UE executes the conditional LTM (e.g., applying the LTM candidate configuration when the execution condition(s) associated with the LTM candidate configuration is fulfilled) and/or initiates an RA procedure to a target candidate cell of the LTM candidate configuration, the UE may stop monitoring a source cell of a source base station (or a current serving cell). In one implementation, while a cell switch procedure is triggered (e.g., due to a conditional LTM is executed by the UE), the UE may stop monitoring a source cell of a source base station (or a current serving cell).

### Ue Assistance Information for Conditional LTM

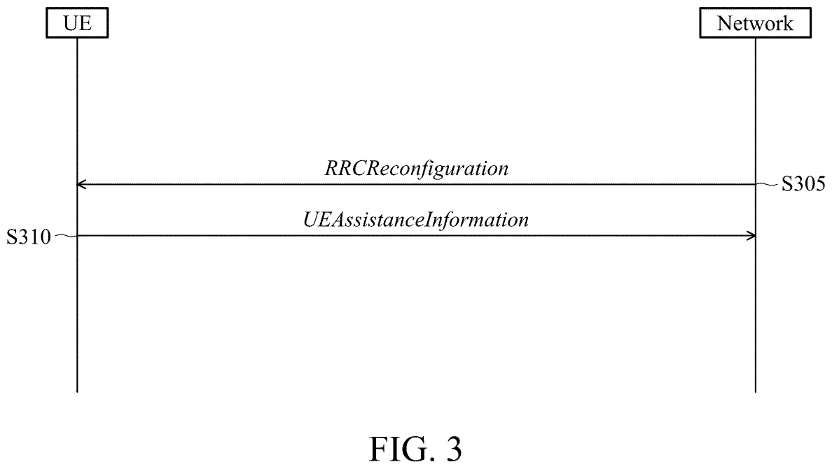

FIG. 3 shows a signaling procedure of transmitting UE assistance information according to an implementation of the present disclosure. In step S305, the network (NW) may initiate this procedure with a UE in the RRC_CONNECTED state when the NW needs UE assistance information. That is, the NW may transmit an RRC Reconfiguration message (e.g., RRCReconfiguration message) to configure the UE to provide certain assistance information and the UE may transmit the related assistance information based on the configuration in a UE assistance information message (e.g., UEAssistanceInformation message) in step S310.

In one implementation, the NW may configure the UE to provide conditional LTM-related assistance information of the UE to the NW. For example, when the UE reports its capability of supporting the conditional LTM, the UE may be considered as a conditional LTM capable UE. Then, the NW may configure this conditional LTM capable UE to provide its conditional LTM-related assistance information. The NW may refer to the conditional LTM-related assistance information provided by the UE before step 202 of FIG. 2.

In one implementation, the UE may provide its current speed (e.g., based on the UE's estimation or GPS information) in the UE assistance information message. In one implementation, the UE may provide its mobility state (e.g. low mobility, medium mobility, or high mobility) in a UE assistance information message. The definitions of different mobility states may follow those specified in TS 38.304. The definitions of different mobility states may be configured by the NW. In one implementation, the UE may provide its trajectory-related information in the UE assistance information message. In one implementation, the UE may provide its location-related information in a UE assistance information message. In another implementation, the UE may provide its preference to use the conditional LTM or not in the UE assistance information. For example, the UE may set its preference as “using the conditional LTM” or the like in cases where the mobility robust or the service interruption may be important for the UE. For example, the UE may set its preference as “not using the conditional LTM” or the like in cases where the power saving may be important for the UE or the UE's capability is limited (e.g., due to the overheating problem).

In one implementation, upon transmitting the UE assistance information including the conditional LTM-related assistance information, a timer T1 starts. The UE may be allowed to transmit another UE assistance information including the conditional LTM-related assistance information upon the timer T1 expires. In another implementation, when the timer T1 is running and the current conditional LTM-related assistance information is different from the one indicated in the last transmission of the UE assistance information message (or the previous transmitted UE assistance information message), the UE is allowed to transmit the UE assistance information message including the conditional LTM-related assistance information. The value of the timer T1 may be configured or a pre-defined value.

### Designs for Conditional LTM Candidate Configuration

In one implementation, the conditional LTM candidate configuration may contain one LTM candidate configuration (of a target candidate cell), one associated conditional LTM execution condition, and one associated LTM candidate ID. The associated conditional LTM execution condition may consist one or more trigger conditions. A trigger condition may be identified by a measurement ID (e.g., a measID), which is used to identify a measurement configuration. It should be noted that the measurement configuration may be associated with a report configuration (or its report configuration ID) and/or a measurement object configuration (or its measurement object ID). It should be also noted that the report configuration may be configured for an L1 measurement or for an L3 measurement. In one implementation, the conditional LTM execution condition is considered to be met (or fulfilled) when one (or all) trigger condition is met (or fulfilled). In one implementation, for the conditional LTM candidate configuration, the trigger condition may be associated with the report configuration, which is associated with a measurement ID configured in the conditional LTM candidate configuration. In one implementation, the report configuration may indicate that its report type is “the conditional LTM trigger condition” or the like, which is used for the conditional LTM. When a measurement event of the report configuration with a report type of “conditional LTM trigger condition” or the like is fulfilled (e.g., based on corresponding parameters), the UE may not report the measurement results to the NW. In one implementation, the report configuration may indicate that its report type is “conditional LTM trigger condition” or the like, which is used for the conditional LTM. When the measurement event of the report configuration with a report type of “conditional LTM trigger condition” or the like is fulfilled (e.g., based on corresponding parameters), the UE may report the measurement results to the NW based on received configuration or control signaling.

In one implementation, the LTM candidate configuration may be configured to be associated with the measurement configuration (or its measurement ID) and the measurement configuration may be associated with the report configuration (or its report configuration ID). When the report type (or a field) of the report configuration is “conditional LTM”, the UE may apply the LTM candidate configuration when the execution condition based on the measurement configuration (or the associated report configuration) is fulfilled. When the report type (or a field) of the report configuration is not “conditional LTM”, the UE may report the measurement results based on the measurement configuration (or the associated report configuration) and not apply the LTM candidate configuration. In one implementation, the NW may change, update or modify the LTM candidate configuration from the traditional LTM to the conditional LTM or from the conditional LTM to the traditional LTM based on an RRC signaling, an MAC CE, or a DCI. It should be noted that the traditional LTM is a cell switch procedure that the network triggers via a Medium Access Control (MAC) Control Element (CE) based on L1 measurements as introduced in 3GPP Release 18. Therefore, there is no execution condition for the traditional LTM. For example, when the UE receives the LTM candidate configuration and the LTM candidate configuration is associated with a report configuration with a report type of “conditional LTM” and the UE receives an RRC signaling, an MAC CE or a DCI to change or disable the report type, the UE may not perform the conditional LTM for the LTM candidate configuration.

In some implementations, the LTM candidate configuration for the traditional LTM may be associated with a configuration of synchronization signal and physical broadcast channel (SS/PBCH) blocks to be used for the L1 measurements and an associated configuration of channel state information (CSI) report configuration.

In one implementation, the LTM candidate configuration for the traditional LTM may be associated with a configuration of CSI reference signals (CSI-RSs) to be used for the L1 measurements and the associated configuration of CSI report configuration.

In some implementations, the LTM candidate configuration for the traditional LTM may be associated with a configuration of SS/PBCH blocks or CSI-RSs to be used for the L3 measurements and an associated configuration of L3 report configuration.

In one implementation, there may be a field in the LTM candidate configuration to indicate whether the LTM candidate configuration is used for the traditional LTM or for the conditional LTM. In one example, when the field is set to a specific value (e.g., true) or present, the LTM candidate configuration may be configured for the conditional LTM. When the field is set to another specific value (e.g., false) or absent, the LTM candidate configuration may be configured for the traditional LTM. In another example, when the field is set to a specific value (e.g., false) or absent, the LTM candidate configuration may be configured for the conditional LTM. When the field is set to another specific value (e.g., true) or present, the LTM candidate configuration may be configured for the traditional LTM. In another example, the field indicates whether the LTM candidate configuration is for the traditional LTM or the conditional LTM. In one implementation, the LTM candidate configuration for the traditional LTM associated with the configuration of SS/PBCH blocks or CSI-RS(s) to be used for the L1 measurements and an associated configuration of CSI report configuration may be considered for the traditional LTM as the default state. The NW may use an RRC signaling, an MAC CE or a DCI to change, update or modify the state to the conditional LTM. In another implementation, the LTM candidate configuration for the traditional LTM associated with a configuration of SS/PBCH blocks or CSI-RSs to be used for the L1 measurements and an associated configuration of CSI report configuration may be considered for the conditional LTM as the default state. The NW may use an RRC signaling, an MAC CE or a DCI to change, update or modify the state to the traditional LTM. It should be noted that when the LTM candidate configuration is considered as the traditional LTM, the UE may report L1 measurement results to the NW and may wait the NW command to switch to another cell. When the LTM candidate configuration is considered as the conditional LTM, the UE may not report the L1 measurement results to the NW. Instead, the UE may apply the LTM candidate configuration when its associated execution condition(s) is fulfilled. The associated execution condition(s) may be determined based on the received configuration of CSI report configuration or based on another configuration (e.g., another measurement configuration or another report configuration). The UE may start evaluating the conditional LTM execution condition(s) associated with the LTM candidate configuration and determine whether the execution condition(s) is fulfilled when the execution condition(s) is enabled, active, valid or configured.

In some implementations, the LTM candidate configuration may be configured with the L1 (or L3) measurement event or report for the traditional LTM, and the L1 (or L3) measurement event or report for the conditional LTM. Which type (L1, L3 or both) to use for the traditional LTM or the conditional LTM may depend on the decision of the NW and/or the UE capabilities. For example, when the UE reports its capability of the L1 measurement for the conditional LTM, the NW may transmit the LTM candidate configuration associated with a L1 measurement event for the conditional LTM. In another example, when the UE reports its capability of the L3 measurement for the conditional LTM, the NW may transmit the LTM candidate configuration associated with a L3 measurement event for the conditional LTM.

In one implementation, the LTM candidate configuration may be associated with a first report configuration for the conditional LTM and/or may be associated with a second report configuration for the traditional LTM. When the first report configuration is present, the LTM candidate configuration may be applied when the execution condition(s) associated with the first report configuration is met (or fulfilled). It should be noted that the UE may start evaluating the conditional LTM execution condition(s) associated with the LTM candidate configuration and determine whether the execution condition(s) is met (or fulfilled) when the execution condition(s) is enabled, active, valid or configured. When the second report configuration is present, the UE may report the measurement results to the NW.

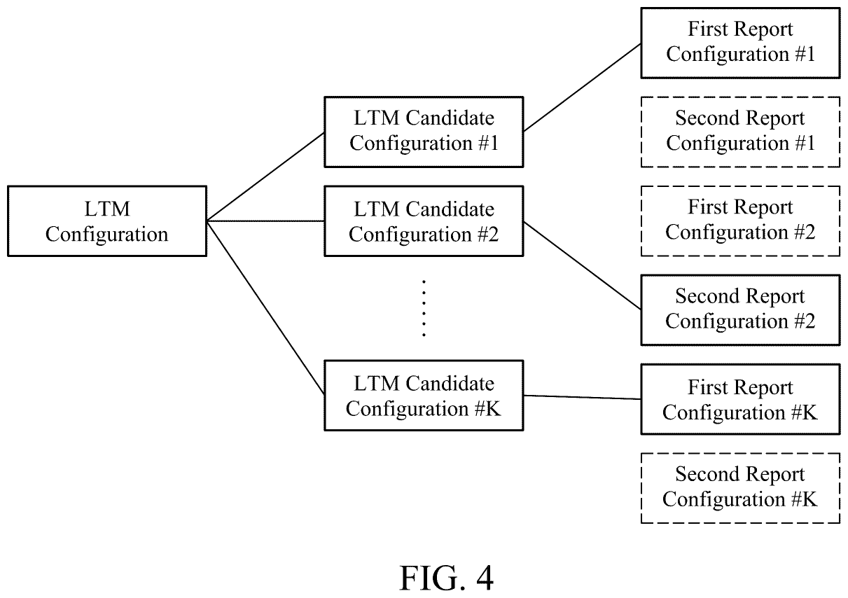

FIG. 4 shows a configuration structure of the LTM configuration comprising one or more LTM candidate configurations according to an implementation of the present disclosure. The LTM configuration may be a list which comprises one or more LTM candidate configurations. For example, as shown in FIG. 4, the LTM configuration comprises K LTM candidate configurations. The UE may report its capability of maximum number of LTM candidate configurations that may be supported in the LTM configuration. Each LTM candidate configuration may be associated with a first report configuration for the conditional LTM and/or a second report configuration for the traditional LTM. For example, the LTM candidate configuration #1 associated with the first report configuration #1 may be considered as a conditional LTM. In another example, the LTM candidate configuration #2 associated with the second report configuration #2 may be considered as a traditional LTM.

In one implementation, when both the first report configuration and the second report configuration are present, the UE may apply both report configurations. For example, the UE may apply the associated LTM candidate configuration when the related execution condition(s) associated with the first report configuration is met (or fulfilled) and the UE may send the measurement results based on the second report configuration. In another implementation, when both the first report configuration and the second report configuration are present, the UE may apply the first report configuration for the conditional LTM and may suspend or release the second report configuration for the traditional LTM. In another implementation, when both the first report configuration and the second report configuration are present, the UE may apply the second report configuration for the traditional LTM and may suspend or release the first report configuration for the conditional LTM. In another implementation, when both the first report configuration and the second report configuration are present, the NW may indicate the UE (e.g., by an RRC signaling, an MAC CE or a DCI) which report configuration to use. In another implementation, the first report configuration and the second report configuration are not allowed to be present as the same time. That is, when the LTM candidate configuration is for the conditional LTM, only the first report configuration may be present. When the LTM candidate configuration is for the traditional LTM, only the second report configuration may be present. It should be noted that the first report configuration may be an L1 based report configuration (e.g., a CSI report configuration) or an L3 based report configuration (e.g., a report configuration with a report configuration ID). It should be also noted that the second report configuration may be an L1 based report configuration (e.g., a CSI report configuration) or an L3 based report configuration (e.g., a report configuration with a report configuration ID).

In one implementation, for each (conditional) LTM ID, when a conditional LTM-related indication is received from the lower layer (e.g., the PHY layer or the MAC layer), indicating that the execution condition(s) associated with the LTM candidate configuration is enabled (or active/configured) and the execution condition(s) is met (or fulfilled), a target candidate cell associated with the LTM candidate configuration is considered as a triggered cell. When more than one triggered cell exists, the UE may select one of the triggered cells as the selected cell for the conditional reconfiguration execution (i.e., the UE may apply the stored LTM candidate configuration of the selected cell). When there is only one triggered cell, the UE may apply the stored LTM candidate configuration of the triggered cell. When multiple NR cells are triggered in the conditional reconfiguration execution, the UE may select which triggered NR cell for execution, e.g. the UE considers beams and beam qualities to select one of the triggered cells for execution. In one implementation, when more than one triggered cell exists (e.g., the associated L1 based execution condition(s) of more than one candidate target cell is met), the MAC layer of the UE may select one of the triggered cells as the selected cell for the conditional reconfiguration execution (i.e., the UE may apply the stored LTM candidate configuration of the selected cell). In another implementation, when more than one triggered cell exists (e.g., the associated L3 based execution condition(s) of more than one candidate target cell is met), the RRC layer of the UE may select one of the triggered cells as the selected cell for the conditional reconfiguration execution (i.e., the UE may apply the stored LTM candidate configuration of the selected cell).

In one implementation, the UE may receive a DCI with a specific field to indicate that the execution condition(s) associated with the LTM candidate configuration is enabled or disabled. When the PHY layer of the UE receives the DCI with the specific field, the PHY layer of the UE may inform the upper layers (e.g., the MAC layer or the RRC layer) that the execution condition(s) associated with the LTM candidate configuration is enabled or disabled. In cases where the UE receives the DCI indicating to enable the execution condition(s) associated with the LTM candidate configuration (e.g., an LTM candidate configuration with a first report configuration), the UE may start evaluating the execution condition(s). In cases where the UE receives the DCI indicating to disable the execution condition(s) associated with the LTM candidate configuration (e.g., an LTM candidate configuration with a first report configuration), the UE may stop evaluating the execution condition(s). In another implementation, the UE may receive the DCI with a specific field to indicate that the execution condition(s) associated with one or more LTM candidate configurations is enabled or disabled. For example, the DCI may indicate that the execution condition of the LTM candidate configuration #1 is enabled and the execution condition of the LTM candidate configuration #3 is disabled. In one implementation, there may be a radio network temporary identifier (RNTI) value for scrambling cyclic redundancy check (CRC) of the DCI for enabling or disabling the execution condition(s) of the LTM candidate configuration. In addition, a specific search space and/or a control resource set (CORESET) may be configured for the UE to receive the DCI.

In one implementation, the UE may receive an MAC CE with a specific field to indicate that the execution condition(s) associated with the LTM candidate configuration is enabled or disabled. When the MAC layer of the UE receives the MAC CE with the specific field, the MAC layer of the UE may inform the upper layers (e.g., the RRC layer) that the execution condition(s) associated with the LTM candidate configuration is enabled or disabled. In cases where the UE receives the MAC CE indicating to enable the execution condition(s) associated with the LTM candidate configuration (e.g., the LTM candidate configuration with the first report configuration), the UE may start evaluating the execution condition(s). In cases where the UE receives the DCI indicating to disable the execution condition(s) associated with the LTM candidate configuration (e.g., the LTM candidate configuration with the first report configuration, the UE may stop evaluating the execution condition(s). In another implementation, the UE may receive the MAC CE with a specific field to indicate that the execution condition(s) associated with one or more LTM candidate configurations is enabled or disabled. For example, the MAC CE may indicate that the execution condition(s) of the LTM candidate configuration #1 is enabled and the execution condition(s) of the LTM candidate configuration #3 is disabled.

In another implementation, the associated conditional LTM execution condition of the conditional LTM candidate configuration may relate to a UE speed. In one implementation, the NW may configure a value of speed threshold for the conditional LTM. For example, when the current UE speed is higher than or equal to the speed threshold, the execution condition is considered as fulfilled and the UE may apply the associated LTM candidate configuration. The speed threshold may be configured or pre-defined. In one implementation, the NW may configure one or more mobility state for the conditional LTM. For example, the NW may configure the high mobility state as the execution condition. Once the UE determines that its current mobility state is high, the UE may apply the associated LTM candidate configuration.

In another implementation, the associated conditional LTM execution condition of the conditional LTM candidate configuration may be related to the UE location. In one implementation, the NW may configure an area (e.g., a distance range from a reference point or a cell set). When the UE is located within the area, the execution condition may not be considered as fulfilled and the UE may not apply the associated LTM candidate configuration. Instead, when the UE is located outside the area, the execution condition may be considered as fulfilled and the UE may apply the associated LTM candidate configuration.

In another implementation, the associated conditional LTM execution condition of the conditional LTM candidate configuration may be related to a life timer. In one implementation, the NW may assign a value to the life timer which is associated with an execution condition. When the life timer expires, the execution condition may be considered as invalid. Instead, when the life timer is running, the execution condition may be considered as valid.

In another implementation, a leaving condition may be provided for the associated conditional LTM execution condition of the conditional LTM candidate configuration. When the leaving condition is met, the execution condition may be considered as invalid. Instead, when the leaving condition is not met, the execution condition may be considered as valid.

### Handling of Conditional LTM Configuration

In one implementation, when the LTM candidate configuration is applied (e.g. by the RRC layer of the UE) due to the LTM cell switch execution (e.g., when receiving an indication from the lower layer indicating that the LTM cell switch execution is successfully completely and/or the associated execution condition(s) is fulfilled), the UE may submit an RRC complete message accordingly.

In one implementation, the UE may stop evaluating the conditional LTM execution condition(s) of the stored LTM candidate configuration(s) once a handover procedure is executed (e.g., a traditional LTM is executed, a conditional LTM is executed, a traditional HO is executed or a CHO is executed) or the UE transitions to the IDLE (or an INACTIVE) mode.

In one implementation, the UE may release all stored LTM candidate configuration(s) (with the execution condition(s) or without the execution condition(s)) once a handover procedure is executed (e.g., a traditional LTM is executed, a conditional LTM is executed, a traditional HO is executed or a CHO is executed). In one implementation, the UE may release the stored LTM candidate configuration(s) except the stored LTM candidate configuration(s) configured for subsequent LTM and/or subsequent conditional LTM, once a handover is executed (e.g., a traditional LTM is executed, a conditional LTM is executed, a traditional HO is executed or a CHO is executed).

In one implementation, the UE may release the stored LTM candidate configuration(s) without the execution condition(s) and/or keep the stored LTM candidate configuration(s) with execution condition(s) once a handover is executed (e.g., a traditional LTM is executed, a conditional LTM is executed, a traditional HO is executed or a CHO is executed).

In one implementation, the UE may release the stored LTM candidate configuration(s) with the execution condition(s) and/or keep the stored LTM candidate configuration(s) without the execution condition(s) once a handover is executed (e.g., a traditional LTM is executed, a conditional LTM is executed, a traditional HO is executed or a CHO is executed).

In one implementation, when the stored LTM candidate configuration is released (either by the UE itself or the NW command) and when the measurement configuration (or its measurement ID) is associated with the stored LTM candidate configuration, the UE may autonomously release the measurement configuration. In one implementation, when the stored LTM candidate configuration associated with the measurement configuration is released (either by the UE itself or the NW command) and when the report configuration (or its report configuration ID) associated with the measurement configuration is configured for the conditional LTM (e.g., using a specific filed in the report configuration), the UE may autonomously release the report configuration. In one implementation, when the stored LTM candidate configuration associated with the measurement configuration is released (either by the UE itself or the NW command) and a measurement object configuration (or its measurement object configuration ID) is associated with the measurement configuration is configured for the conditional LTM (e.g., using a specific filed in the report configuration), the UE may autonomously release the measurement object configuration.

### Coexistence of Traditional LTM and Conditional LTM

In one implementation, before the conditional LTM execution condition is satisfied, upon reception of the HO command (without the CHO configuration) (e.g., from a source base station), the UE may execute a HO procedure based on the HO command, regardless of any previously received conditional LTM candidate configuration. In one implementation, before the conditional LTM execution condition is satisfied, upon reception of the MAC CE for the LTM cell switch (e.g., an LTM Cell Switch Command MAC CE as introduced in TS 38.321 of Release 18) (e.g., from a source base station), the UE may execute a HO procedure based on the HO command, regardless of any previously received conditional LTM candidate configuration.

In some implementations, when the (active, enabled or configured) execution condition(s) of the LTM candidate configuration is fulfilled, the UE may stop the L1/L3 measurements (or L1/L3 measurement reporting) of any configured traditional LTM candidate configuration (stored by the UE), stop any evaluation of the configured conditional LTM candidate configuration (stored by the UE) and/or stop any evaluation of any configured CHO/CPA/CPC. It should be noted that CPA means Conditional PSCell Addition and CPC means Conditional PSCell Change as introduced in TS 38.300 and TS 38.331 of Release 18. It should be noted that the UE may evaluate the execution condition(s) associated with the LTM candidate configuration when the execution condition(s) is active, enabled, or configured. In another implementation, when the (active, enabled or configured) execution condition(s) of the LTM candidate configuration is fulfilled, the UE may stop the L1/L3 measurements (or the L1/L3 measurement reporting) of any configured traditional LTM candidate configuration (stored by the UE) based on a NW command (e.g., an RRC signaling, an MAC CE or a DCI). In another implementation, when the (active, enabled or configured) execution condition(s) of the LTM candidate configuration is fulfilled, the UE may stop any evaluation of the configured conditional LTM candidate configuration (stored by the UE) based on a NW command (e.g., an RRC signaling, an MAC CE or a DCI) and/or based on whether any subsequent conditional LTM or subsequent traditional LTM associates with the configured conditional LTM candidate configuration. For example, when the subsequent conditional LTM or the subsequent traditional LTM associated with the configured LTM candidate configuration is configured, the UE may keep evaluating the execution condition(s) of the LTM candidate configuration (e.g., when the subsequent conditional LTM or the subsequent traditional LTM associated with the configured LTM candidate configuration replaces the LTM candidate configuration).

In some implementations, when the LTM triggered MAC CE is received (e.g., an LTM Cell Switch Command MAC CE as introduced in TS 38.321 of Release 18), the UE may stop the L1/L3 measurements (or the L1/L3 measurement reporting) of any configured traditional LTM candidate configuration (stored by the UE), stop any evaluation of the configured conditional LTM candidate configuration (stored by the UE) and/or stop any evaluation of any configured CHO/CPA/CPC. In another implementation, when the LTM triggered MAC CE is received (e.g., an LTM Cell Switch Command MAC CE as introduced in TS 38.321 of Release 18), the UE may stop the L1/L3 measurements (or the L1/L3 measurement reporting) of any configured traditional LTM candidate configuration (stored by the UE) based on a NW command (e.g., an RRC signaling, an MAC CE or a DCI). In another implementation, when the LTM triggered MAC CE is received (e.g., an LTM Cell Switch Command MAC CE as introduced in TS 38.321 of Release 18), the UE may stop any evaluation of the configured conditional LTM candidate configuration (stored by the UE).

In another implementation, when the LTM triggered MAC CE is received (e.g., an LTM Cell Switch Command MAC CE as introduced in TS 38.321 of Release 18), the UE may stop any evaluation of the configured conditional LTM candidate configuration (stored by the UE) based on a NW command.

### Coexistence of CHO/CPA/CPC and Conditional LTM

In some implementations, when the (active, enabled or configured) execution condition(s) of the conditional LTM configuration is fulfilled, the UE may stop any evaluation of any configured CHO/CPA/CPC. It should be noted that CPA means Conditional PSCell Addition and CPC means Conditional PSCell Change as introduced in TS 38.300 and TS 38.331 of Release 18. In another implementation, when the (active, enabled or configured) execution condition(s) of the LTM candidate configuration is fulfilled, the UE may stop any evaluation of any configured CHO/CPA/CPC based on a NW command (e.g., an RRC signaling, an MAC CE or a DCI).

### Ul Synchronization for Conditional LTM

In some implementations, when the (active, enabled or configured) execution condition(s) of the CHO/CPA/CPC command is fulfilled, the UE may stop any evaluation of the configured conditional LTM candidate configuration (stored by the UE). It should be noted that the UE may evaluate the execution condition(s) associated with the LTM candidate configuration when the execution condition(s) is active, enabled, or configured. In another implementation, when the (active, enabled or configured) execution condition(s) of the CHO/CPA/CPC command is fulfilled, the UE may stop any evaluation of the configured conditional LTM candidate configuration (stored by the UE) based on the NW command (e.g., an RRC signaling, an MAC CE or a DCI).

For the traditional LTM or the conditional LTM procedure, the early synchronization phase, e.g., step 204a and step 204b in FIG. 2 may be performed to shorten the latency and interruption time caused by the HO procedure (or the LTM cell switch procedure). In one implementation, the NW (or a serving gNB, or a serving DU) may configure the UE to initiate the (early) UL TA acquisition procedure to one or more target candidate cell. In one implementation, the NW (or a serving gNB, or a serving DU) may transmit a DCI (or PDCCH order) to trigger the UE to perform the early UL TA acquisition by transmitting a preamble without receiving any RA response (RAR) (e.g., RAR from a target candidate cell or a current serving cell). For example, after transmitting a preamble to a candidate target cell (or a target base station of the candidate target cell), the UE may receive TA-related information (e.g., via an MAC CE) for the early UL TA acquisition from a source cell (or a source base station of the source cell).

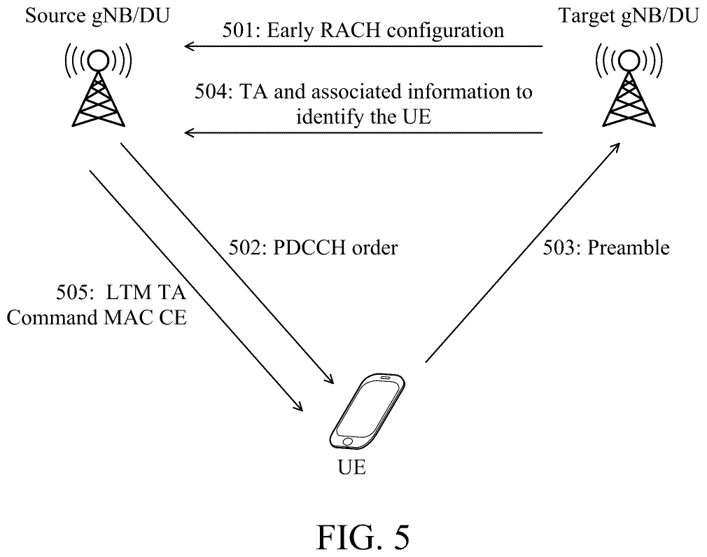

FIG. 5 shows an early UL TA acquisition procedure triggered by a PDCCH order according to an implementation of the present disclosure. To provide proper PDCCH order information for the UE to transmit a preamble, the target gNB/DU may provide the early RACH configuration of a target candidate cell to the source gNB/DU as shown in step 501 of FIG. 5. The early RACH configuration may include random access preamble indexes, SS/PBCH indexes, and/or a PRACH mask index, but it should not be limited in the disclosure. Upon receiving the PDCCH order as shown in step 502 of FIG. 5, the UE may transmit a preamble based on the received PDCCH order in step 503. The received PDCCH order may indicate whether the UE shall transmit a preamble on a normal UL (NUL) carrier or a supplementary UL (SUL) carrier. In another implementation, the UE may use CBRA resource(s) or CFRA (resources) provided by the NW (e.g., in RRC signaling or an MAC CE) to transmit a preamble to a target candidate cell. Whether the UE may use the CBRA resource(s) or the CFRA (resources) on the NUL carrier or the SUL carrier may depend on a configured threshold. For example, when the signaling strength (e.g., current determined RSRP) is lower than or equal to the threshold, the UE may use the RA resources on the SUL carrier. In another example, when the signaling strength (e.g., a current determined RSRP) is higher than or equal to the threshold, the UE may use the RA resources on the NUL carrier. When successfully receiving the preamble from the UE, the target gNB/DU may transmit TA value and/or associated information (e.g. a preamble index, RA occasion information (i.e. RA-RNTI), or a candidate cell identity) for the source gNB/DU to identify the UE as shown in step 504 of FIG. 5. When receiving these information for the target gNB/DU, the source gNB/DU may transmit an LTM TA Command MAC CE or the like to the UE shown in step 505 of FIG. 5. In one implementation, the LTM Cell Switch Command MAC CE may be used for both the traditional LTM and the conditional LTM. In one implementation, the LTM Cell Switch Command MAC CE may include a field to indicate whether the LTM Cell Switch Command MAC CE is for the traditional LTM or the conditional LTM. Different field(s) in the LTM Cell Switch Command MAC CE may be present or absent for the tradition LTM case or the conditional LTM case.

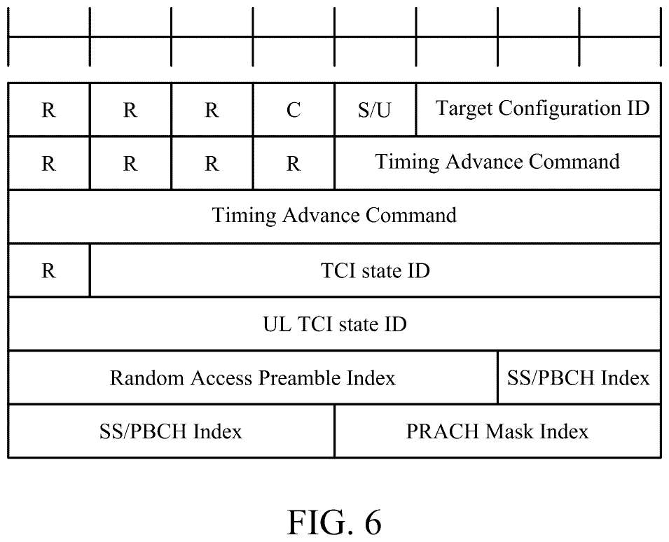

FIG. 6 shows an LTM Cell Switch Command MAC CE according to an implementation of the present disclosure. It should be noted that one or more field(s) in the LTM Cell Switch Command MAC CE may be present or absent for different usage. It should be also noted that one or more field(s) in the LTM Cell Switch Command MAC CE may be defined differently based on different usages. For example, when the UE only supports to store a maximum of 8 LTM candidate configurations, the Target Configuration ID field may be 3 bits. When the UE supports storing a maximum of 16 LTM candidate configurations, the Target Configuration ID field may be 4 bits. The UE may determine the bits of the Target Configuration ID field based on the received configuration. For example, when the maximum received target configuration ID is 10 (or the number of received LTM candidate configuration is greater than or equal to 8), the Target Configuration ID field may be considered or determined to be 4 bits. When the maximum received target configuration ID is 7 (or the number of received LTM candidate configuration is less than or equal to 8), the Target Configuration ID field may be considered or determined to be 3 bits. As shown in FIG. 6, the LTM Cell Switch Command MAC CE is identified by an MAC subheader with a specific eLCID (extended LCID) and has a variable size with following fields:
R: reserved bit, set to 0.

Target Configuration ID: this field indicates the index of the candidate target configuration to apply for the LTM cell switch, corresponding to ltm-CandidateId minus 1 as specified in TS 38.331 of Release 18. The length of the field is 3 bits.

Timing Advance Command: this field indicates whether the TA is valid for the LTM target cell (i.e. a special cell (SpCell) corresponding to the target configuration indicated by the Target Configuration ID field). When the value of this field is set to FFF, this field indicates that no valid timing adjustment is available for the primary TAG (pTAG) of the LTM target cell. Otherwise, this field indicates the index value TA used to control the amount of timing adjustment that the MAC entity has to apply in TS 38.213 of Release 18, and the UE can skip the Random Access procedure for this LTM cell switch. The length of the field is 12 bits.

TCI state ID: this field indicates and activates the TCI state for the LTM target cell (i.e. the SpCell of the target configuration indicated by the Target Configuration ID field). The TCI state is identified by TCI-StateId in ltm-DL-OrJointTCI-StateToAddModList as specified in TS 38.331 of Release 18. When the value of unifiedTCI-StateType in the configuration indicated by the Target Configuration ID field is joint, this field is for joint TCI state; otherwise, this field is used for the downlink TCI state. The length of the field is 7 bits;

UL TCI state ID: This field indicates and activates the uplink TCI state for the LTM target cell (i.e. the SpCell of the target configuration indicated by the Target Configuration ID field). The most significant bits of the UL TCI state ID are considered as reserved bits and the remainder 6 bits indicate the TCI-UL-Stateld in ltm-UL-TCI-StatesToAddModList as specified in TS 38.331 of Release 18. This field is included when the value of unifiedTCI-StateType in the configuration indicated by the Target Configuration ID field is separate. The length of the field is 8 bits.

C: this field indicates the presence of the contention-free Random Access Resources fields. When the value of this field is set to 1, the following fields are present, including the Random Access Preamble Index field, the S/U field, the SS/PBCH Index field and the PRACH Mask Index field. When the value of this field is set to 0, the Random Access Preamble index field, the SS/PBCH index field and the PRACH Mask index field are absent, and the S/U field is considered as the Reserved field.

S/U: this field indicates which UL carrier to transmit the PRACH of the contention-free Random Access Resources. When the value of this field is set to 1, the SUL is used; otherwise, the NUL is used. The length of the field is 1 bit.

Random Access Preamble Index: this field indicates the Random Access Preamble index of the contention-free Random Access Resources. The length of the field is 6 bits.

SS/PBCH Index: this field indicates the SS/PBCH that shall be used to determine the RACH occasion for the PRACH transmission of the contention-free Random Access Resources. The length of the field is 6 bits.

PRACH Mask Index: this field indicates the RACH occasion(s) associated with the SS/PBCH indicated by “SS/PBCH Index” for the PRACH transmission of the contention-free Random Access Resources, referring to the rach-ConfigDedicated (if not provided otherwise to the rach-ConfigCommon) in the UL BWP configuration of firstActiveUplinkBWP-Id as specified in TS 38.331 of Release 18. The length of the field is 4 bits.

In one implementation, one of the R fields of the LTM Cell Switch Command MAC CE may be used to indicate whether the LTM Cell Switch Command MAC CE is used for the traditional LTM or the conditional LTM. For example, when the selected R field is set to a specific value (e.g., 0), the LTM Cell Switch Command MAC CE is used for the traditional LTM and the Target Configuration ID field is used to indicate a specific LTM candidate configuration without the execution condition(s). When the selected R field is set to a specific value (e.g., 1), the LTM Cell Switch Command MAC CE is used for the conditional LTM and the Target Configuration ID field is used to indicate a specific LTM candidate configuration with the execution condition(s).

In one implementation, the C field of the LTM Cell Switch Command MAC CE for the conditional LTM may always be set to 0. That is, the purpose of the LTM Cell Switch Command MAC CE for the conditional LTM is to provide the TA command for the early UL acquisition to the UE, not to instruct the UE to perform the RA procedure when receiving the LTM Cell Switch Command MAC CE.

In one implementation, the TCI state ID of the LTM Cell Switch Command MAC CE for the conditional LTM may be absent. In another implementation, the R field may be used to indicate whether the TCI state ID of the LTM Cell Switch Command MAC CE for the conditional LTM is present.

In one implementation, the UL TCI state ID of the LTM Cell Switch Command MAC CE for the conditional LTM may be absent. In another implementation, the R field may be used to indicate whether the UL TCI state ID of the LTM Cell Switch Command MAC CE for the conditional LTM is present.

In one implementation, the conditional LTM and the traditional LTM may share the same ID pool. That is, for the UE, the configured LTM candidate configuration with the execution condition(s) and another configured LTM candidate configuration without the execution condition(s) may not be configured with the same LTM ID. In one implementation, since the conditional LTM and the traditional LTM share the same ID pool, the total number of the configured LTM candidate configuration(s) with the execution condition(s) and the configured LTM candidate configuration(s) without the execution condition(s) that the UE may store may be pre-defined or fixed (e.g., 8). For example, a conditional LTM capable UE may be configured with up to 8 LTM configuration, including LTM candidate configuration(s) with execution condition(s) and LTM candidate configuration(s) without any execution condition(s). In one example, a conditional LTM capable UE may be configured with up to 8 LTM candidate configurations with associated execution conditions. In another implementation, when the UE may support storing more LTM candidate configuration(s) (e.g., 16), the UE may support the capability to the NW. When the NW receives the capability, the NW may inform the UE the maximum value of the target configuration ID to configure (e.g., via an RRC signaling or an MAC CE).

In one implementation, the conditional LTM and the traditional LTM may not share the same ID pool. That is, for the UE, the configured LTM candidate configuration with the execution condition(s) and another configured LTM candidate configuration without the execution condition(s) may be configured with the same LTM ID. In one implementation, the maximum number of the configured LTM candidate configuration(s) with the execution condition(s) that the UE may store may be pre-defined or fixed (e.g., 8). In one implementation, the maximum number of the configured LTM candidate configuration(s) without the execution condition(s) that the UE may store may be pre-defined or fixed (e.g., 8). For example, the UE may be configured with 8 configured LTM candidate configuration(s) with the execution condition(s) and 8 configured LTM candidate configuration(s) without any execution condition(s) at the same time.

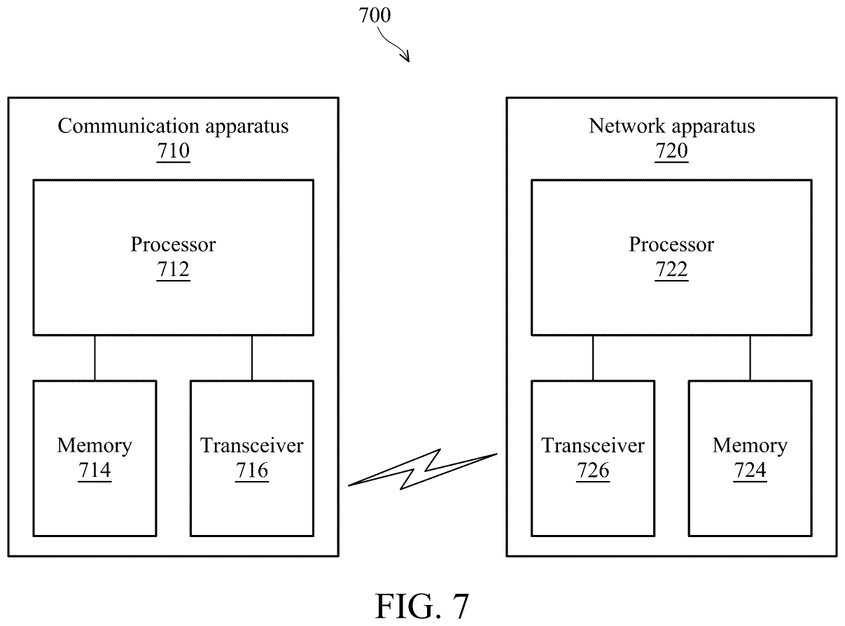

FIG. 7 illustrates an example communication system 700 having an example communication apparatus 710 and an example network apparatus 720 in accordance with an implementation of the present disclosure. Each of communication apparatus 710 and network apparatus 720 may perform various functions to implement schemes, techniques, processes and methods described herein pertaining to configuration of conditional LTM procedure, including scenarios/schemes described above as well as process 700 described below.

The communication apparatus 710 may be a part of an electronic apparatus, which may be a UE such as a portable or mobile apparatus, a wearable apparatus, a wireless communication apparatus or a computing apparatus. For instance, the communication apparatus 710 may be implemented in a smartphone, a smartwatch, a personal digital assistant, a digital camera, or a computing equipment such as a tablet computer, a laptop computer or a notebook computer. The communication apparatus 710 may also be a part of a machine type apparatus, which may be an IoT, NB-IoT, or IIOT apparatus such as an immobile or a stationary apparatus, a home apparatus, a wire communication apparatus or a computing apparatus. For instance, the communication apparatus 710 may be implemented in a smart thermostat, a smart fridge, a smart door lock, a wireless speaker or a home control center. Alternatively, the communication apparatus 710 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. The communication apparatus 710 may include at least some of those components shown in FIG. 7 such as a processor 712, for example. The communication apparatus 710 may further include one or more other components not pertinent to the proposed scheme of the present disclosure (e.g., internal power supply, display device and/or user interface device), and, thus, such component(s) of the communication apparatus 710 are neither shown in FIG. 7 nor described below in the interest of simplicity and brevity.

The network apparatus 720 may be a part of an electronic apparatus, which may be a network node such as a BS, a small cell, a router or a gateway. For instance, the network apparatus 720 may be implemented in a gNB in a 5G, B5G, 6G, IoT, NB-IoT or IIOT network. Alternatively, the network apparatus 720 may be implemented in the form of one or more IC chips such as, for example and without limitation, one or more single-core processors, one or more multi-core processors, or one or more RISC or CISC processors. The network apparatus 720 may include at least some of those components shown in FIG. 7 such as a processor 722, for example. The network apparatus 720 may further include one or more other components not pertinent to the proposed scheme of the present disclosure (e.g., internal power supply, display device and/or user interface device), and, thus, such component(s) of the network apparatus 720 are neither shown in FIG. 7 nor described below in the interest of simplicity and brevity.

In one aspect, each of the processor 712 and the processor 722 may be implemented in the form of one or more single-core processors, one or more multi-core processors, or one or more CISC processors. That is, even though a singular term “a processor” is used herein to refer to the processor 712 and the processor 722, each of the processor 712 and the processor 722 may include multiple processors in some implementations and a single processor in other implementations in accordance with the present disclosure. In another aspect, each of the processor 712 and the processor 722 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of the processor 712 and the processor 722 is a special-purpose machine specifically designed, arranged and configured to perform specific tasks including configuration of conditional LTM procedure in a UE (e.g., as represented by the communication apparatus 710) and a gNB (e.g., as represented by the network apparatus 720) in accordance with various implementations of the present disclosure.

In some implementations, the communication apparatus 710 may also include a transceiver 716 coupled to the processor 712 and capable of wirelessly transmitting and receiving control and data signals. In some implementations, the transceiver 716 may be capable of wirelessly communicating with different types of gNBs of different RATs. In some implementations, the transceiver 716 may be equipped with a plurality of antenna ports (not shown) such as, for example, four antenna ports. That is, the transceiver 716 may be equipped with multiple transmit antennas and multiple receive antennas for multiple-input multiple-output (MIMO) wireless communications. In some implementations, the network apparatus 720 may also include a transceiver 726 coupled to the processor 722 and capable of wirelessly transmitting and receiving control and data signals. In some implementations, the transceiver 726 may be capable of wirelessly communicating with different types of UEs of different RATs. In some implementations, the transceiver 726 may be equipped with a plurality of antenna ports (not shown) such as, for example, four antenna ports. That is, the transceiver 726 may be equipped with multiple transmit antennas and multiple receive antennas for MIMO wireless communications. Accordingly, the communication apparatus 710 and the network apparatus 720 may wirelessly communicate with each other via the transceiver 716 and transceiver 726, respectively.

In some implementations, the communication apparatus 710 may further include a memory 714 coupled to the processor 712 and capable of being accessed by processor 712 and storing data therein. In some implementations, the network apparatus 720 may further include a memory 724 coupled to the processor 722 and capable of being accessed by the processor 722 and storing data therein. Each of the memory 714 and the memory 724 may include a type of random-access memory (RAM) such as dynamic RAM (DRAM), static RAM (SRAM), thyristor RAM (T-RAM) and/or zero-capacitor RAM (Z-RAM). Alternatively, or additionally, each of the memory 714 and memory 724 may include a type of read-only memory (ROM) such as mask ROM, programmable ROM (PROM), erasable programmable ROM (EPROM) and/or electrically erasable programmable ROM (EEPROM). Alternatively, or additionally, each of the memory 714 and the memory 724 may include a type of non-volatile random-access memory (NVRAM) such as flash memory, solid-state memory, ferroelectric RAM (FeRAM), magnetoresistive RAM (MRAM) and/or phase-change memory.

Each of the communication apparatus 710 and the network apparatus 720 may be a communication entity capable of communicating with each other using various proposed schemes in accordance with the present disclosure. For illustrative purposes and without limitation, a description of operations, functionalities, and capabilities of the communication apparatus 710, implemented in or as a UE (e.g., the UE in FIGS. 2˜3), and the network apparatus 720, implemented in or as a gNB (e.g., the gNB in FIG. 2 or the NW in FIG. 3), is provided below.

According to certain proposed schemes of the present disclosure, the processor 712 of the communication apparatus 710 may receive, via the transceiver 716, one or more radio resource control (RRC) messages from the network apparatus 720. Then, the processor 712 may be configured with one or more LTM commands included in the one or more RRC messages, wherein a total number of the one or more LTM commands does not exceed a predetermined number, the one or more LTM commands comprise at least one of a first type of LTM command and a second type of LTM command, the first type of LTM command includes a first target cell configuration of a first target cell and a first execution condition, and the second type of LTM command includes a second target cell configuration of a second target cell without any execution condition. In an implementation, up to the predetermined number (e.g., 8) of LTM commands may be stored in the memory 714.

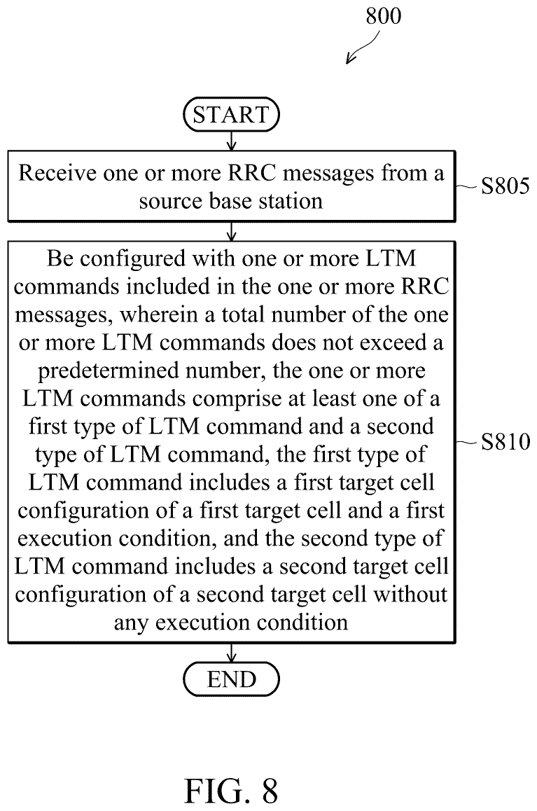

FIG. 8 illustrates an example process 800 in accordance with an implementation of the present disclosure. The process 800 may be an example implementation of above scenarios/schemes, whether partially or completely, with respect to the conditional Layer 1/Layer 2 (L1/L2) triggered mobility (LTM) procedure. The process 800 may represent an aspect of implementation of features of the communication apparatus 710. The process 800 may include one or more operations, actions, or functions as illustrated by one or more of blocks S805 and S810. Although illustrated as discrete blocks, various blocks of the process 800 may be divided into additional blocks, combined into fewer blocks, or eliminated, depending on the desired implementation. Moreover, the blocks of the process 800 may be executed in the order shown in FIG. 8 or, alternatively, in a different order. The process 800 may be implemented by the communication apparatus 710 or any suitable UE. Solely for illustrative purposes and without limitation, the process 800 is described below in the context of the communication apparatus 710 as a UE and the network apparatus 720 as a gNB or a BS. The process 800 may begin at block S805.

In S805, the process 800 may involve the processor 712 of the communication apparatus 710 receiving, via the transceiver 716, one or more radio resource control (RRC) messages from the network apparatus 720. The process 800 may proceed from S805 to S810.

In S810, the process 800 may involve the processor 712 of the communication apparatus 710 being configured with one or more LTM commands included in the one or more RRC messages, wherein a total number of the one or more LTM commands does not exceed a predetermined number, the one or more LTM commands comprise at least one of a first type of LTM command and a second type of LTM command, the first type of LTM command includes a first target cell configuration of a first target cell and a first execution condition, and the second type of LTM command includes a second target cell configuration of a second target cell without any execution condition.

In some implementations, the UE is configured to provide assistance information to the source base station for determining whether a conditional LTM command that is the first type of LTM command is required.

In some implementations, for the first type of LTM command, the process 800 may involve the processor 712 of the communication apparatus 710 determining whether the first execution condition is activated and performing one of the following: evaluating the first execution condition when the first execution condition is activated; and stopping evaluating the first execution condition when the first execution condition is not activated.

In some implementations, the predetermined number is 8.

In some implementations, the processor 712 of the communication apparatus 710 stops monitoring a source cell of the source base station when a cell switch procedure is triggered.

In some implementations, for the first type of LTM command, the process 800 may involve the processor 712 of the communication apparatus 710 evaluating the first execution condition, and performing one of the following: executing a handover procedure based on a handover command when the first execution condition is not fulfilled and the handover command is received from the source base station, and triggering a cell switch procedure by applying the first target cell configuration when the first execution condition is fulfilled.

In some implementations, the first target cell is a triggered cell when the first execution condition is L3 based and is fulfilled. In cases where more than one triggered cell exists, an RRC layer of the UE selects one of the triggered cells as a selected cell and applies an associated target cell configuration of the selected cell.

In some implementations, the first target cell is a triggered cell when the first execution condition is L1 based and is fulfilled. In cases where more than one triggered cell exists, a Medium Access Control (MAC) layer of the UE selects one of the triggered cells as a selected cell and applies an associated target cell configuration of the selected cell.

In some implementations, the processor 712 of the communication apparatus 710 stops evaluating the first execution condition when the UE transitions to an RRC_IDEL state.

In some implementations, one of the one or more LTM commands is the first type of LTM command and the first execution condition of the one of the one or more LTM commands is associated with a measurement ID. The processor 712 of the communication apparatus 710 autonomously removes a report configuration associated with the measurement ID when the one of the one or more LTM commands is released.

While the disclosure has been described by way of example and in terms of the preferred embodiments, it should be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for a Layer 1/Layer 2 (L1/L2) triggered mobility (LTM) procedure, wherein the method is implemented by a user equipment (UE), and comprises:
receiving one or more radio resource control (RRC) messages from a source base station; and
being configured with one or more LTM commands included in the one or more RRC messages, wherein a total number of the one or more LTM commands does not exceed a predetermined number;
wherein the one or more LTM commands comprise at least one of a first type of LTM command and a second type of LTM command, the first type of LTM command includes a first target cell configuration of a first target cell and a first execution condition, and the second type of LTM command includes a second target cell configuration of a second target cell without any execution condition.

2. The method for an LTM procedure as claimed in claim 1, wherein the UE is configured to provide assistance information to the source base station for determining whether a conditional LTM command that is the first type of LTM command is required.

3. The method for an LTM procedure as claimed in claim 1, wherein for the first type of LTM command, and the method further comprises:
determining whether the first execution condition is activated;
performing one of the following:
evaluating the first execution condition when the first execution condition is activated; and
stopping evaluating the first execution condition when the first execution condition is not activated.

4. The method for an LTM procedure as claimed in claim 1, wherein the predetermined number is 8.

5. The method for an LTM procedure as claimed in claim 1, wherein the UE stops monitoring a source cell of the source base station when a cell switch procedure is triggered.

6. The method for an LTM procedure as claimed in claim 1, wherein for the first type of LTM command, and the method further comprises:
evaluating the first execution condition; and
performing one of the following:
executing a handover procedure based on a handover command when the first execution condition is not fulfilled and the handover command is received from the source base station; and
triggering a cell switch procedure by applying the first target cell configuration when the first execution condition is fulfilled.

7. The method for an LTM procedure as claimed in claim 6, wherein the first target cell is a triggered cell when the first execution condition is L3 based and is fulfilled; and
in cases where more than one triggered cell exists, an RRC layer of the UE selects one of the triggered cells as a selected cell and applies an associated target cell configuration of the selected cell.

8. The method for an LTM procedure as claimed in claim 6, wherein the first target cell is a triggered cell when the first execution condition is L1 based and is fulfilled; and
in cases where more than one triggered cell exists, a Medium Access Control (MAC) layer of the UE selects one of the triggered cells as a selected cell and applies an associated target cell configuration of the selected cell.

9. The method for an LTM procedure as claimed in claim 6, further comprising:
stopping evaluating the first execution condition when the UE transitions to an RRC_IDEL state.

10. The method for an LTM procedure as claimed in claim 1, wherein one of the one or more LTM commands is the first type of LTM command and the first execution condition of the one of the one or more LTM commands is associated with a measurement ID, and the method further comprises:
autonomously removing a report configuration associated with the measurement ID when the one of the one or more LTM commands is released.

11. An apparatus for a Layer 1/Layer 2 (L1/L2) triggered mobility (LTM) procedure, comprising:
a transceiver which, during operation, wirelessly communicates with at least one network node; and
a processor communicatively coupled to the transceiver such that, during operation, the processor performs operations comprising:
receiving one or more radio resource control (RRC) messages from a source base station;
being configured with one or more LTM commands included in the one or more RRC messages, wherein a total number of the one or more LTM commands does not exceed a predetermined number;
wherein the one or more LTM commands comprise at least one of a first type of LTM command and a second type of LTM command, the first type of LTM command includes a first target cell configuration of a first target cell and a first execution condition, and the second type of LTM command includes a second target cell configuration of a second target cell without any execution condition.

12. The apparatus for an LTM procedure as claimed in claim 11, wherein the apparatus is configured to provide assistance information to the source base station for determining whether a conditional LTM command that is the first type of LTM command is required.

13. The apparatus for an LTM procedure as claimed in claim 11, wherein for the first type of LTM command, the processor further performs operations comprising:
determining whether the first execution condition is activated;
performing one of the following:
evaluating the first execution condition when the first execution condition is activated; and
stopping evaluating the first execution condition when the first execution condition is not activated.

14. The apparatus for an LTM procedure as claimed in claim 11, wherein the predetermined number is 8.

15. The apparatus for an LTM procedure as claimed in claim 11, wherein the apparatus stops monitoring a source cell of the source base station when a cell switch procedure is triggered.

16. The apparatus for an LTM procedure as claimed in claim 11, wherein for the first type of LTM command, the processor further performs operations comprising:
evaluating the first execution condition; and
performing one of the following:
executing a handover procedure based on a handover command when the first execution condition is not fulfilled and the handover command is received from the source base station; and
triggering a cell switch procedure by applying the first target cell configuration when the first execution condition is fulfilled.

17. The apparatus for an LTM procedure as claimed in claim 16, wherein the first target cell is a triggered cell when the first execution condition is L3 based and is fulfilled; and
in cases where more than one triggered cell exists, an RRC layer of the UE selects one of the triggered cells as a selected cell and applies an associated target cell configuration of the selected cell.

18. The apparatus for an LTM procedure as claimed in claim 16, wherein the first target cell is a triggered cell when the first execution condition is L1 based and is fulfilled; and
in cases where more than one triggered cell exists, a Medium Access Control (MAC) layer of the apparatus selects one of the triggered cells as a selected cell and applies an associated target cell configuration of the selected cell.

19. The apparatus for an LTM procedure as claimed in claim 16, wherein the processor further performs operations comprising:
stopping evaluating the first execution condition when the apparatus transitions to an RRC_IDEL state.

20. The apparatus for an LTM procedure as claimed in claim 11, wherein one of the one or more LTM commands is the first type of LTM command and the first execution condition of the one of the one or more LTM commands is associated with a measurement ID, and the processor further performs operations comprising:
autonomously removing a report configuration associated with the measurement ID when the one of the one or more LTM commands is released.

21. A method for a Layer 1/Layer 2 (L1/L2) triggered mobility (LTM) procedure, wherein the method is implemented by a source base station, and comprises:
transmitting one or more radio resource control (RRC) messages to a user equipment (UE), wherein one or more LTM commands included in the one or more RRC messages are configured to the UE, a total number of the one or more LTM commands does not exceed a predetermined number, the one or more LTM commands comprise at least one of a first type of LTM command and a second type of LTM command, the first type of LTM command includes a first target cell configuration of a first target cell and a first execution condition, and the second type of LTM command includes a second target cell configuration of a second target cell without any execution condition.

22. The method for an LTM procedure as claimed in claim 21, wherein the predetermined number is 8.
